(19) United States
(12) Patent Application Publication
(10) Pub. No.: US 2007/0209218 A1
(43) Pub. Date: Sep. 13, 2007

(54) SEMI-PROFESSIONAL CAN OPENER

(76) Inventor: Bruno Herren, Hergiswil (CH)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 11/681,010

(22) Filed: Mar. 1, 2007

(30) Foreign Application Priority Data
Mar. 10, 2006 (CH) CH-00381/06

(51) Int. Cl. B67B 7/70; B67B 7/46

(52) U.S. Cl. 30/418

(57) ABSTRACT

A can opener for semi-professional use includes a cylindrical functional part which is connected to a crank, that may be inserted from two sides through an annular housing which is fastened on a stand. The functional part is connected with a positive and non-positive fit with a bayonet-like closure in this housing preferably by way of screwing, to a fastening ring. By way of this design, the functional part may be quickly assembled in this housing and be removed therefrom again. The can opener may be permanently fastened on a horizontal surface or a vertical wall by a fastening means. A support rod and a support surface fastened to the same are fastened with the functional part on the housing, so that the support surface prevents cans to be opened from falling down.

### TECHNICAL FIELD

The present invention describes a can opener to be actuated manually, whose functional part may be fastened on a stand.

### STATE OF THE ART

Nowadays, manually actuated can openers are to be found in almost every household and many steps have been taken in the last years to increase the user friendliness.

The functional part of a can opener classically comprised a cutter wheel which severed the can at the can lid within a peripheral edge, whilst a driver wheel on the outer edge of the can supported the cutting mechanism. The cutter wheel and the driver wheel were coupled to one another by way of meshing cogs. Sharp edges arose on the edge of the can and on the separated lid by way of the cut in the can lid, on which the user could easily injure himself. Furthermore, a cut-open can was only reclosable when the lid was not completely removed from the can.

Newer can openers such as disclosed in EP0541620, use a cutter wheel which severs the edge on the outer edge of the can, whilst the driver wheel runs along on the inner side and on the upper region of the edge. A rest element holds the can to be opened in a predefined desired angular position to the can opener. These can openers are called safety can openers, and are mechanically more complex than the can opener with the classical cutting mechanism. The advantages lie in the reclosure ability and the harmless cut edges of the cans.

A further idea for increasing the user friendliness was the matching of the cutting mechanism to right-handed people and to left-handed people. There are also some examples of embodiments of can openers with which the handedness is variable.

As described in DE 19619989, the idea occurred of designing the functional part of the manually operable can opener for left-handed and right-handed people in a manner such that the functional part may be stuck onto the hand grip in two positions offset by 180°. This change of the handedness of the can opener may be carried out with a few hand manipulations in a rapid manner and with little effort. Thus these can openers may be used by left-handed people and right-handed people.

A can opener is also described in U.S. Pat. No. 6,119,352, which before use may be set with a lever to a left-handed person or to a right-handed person.

The operating comfort of can openers was increasingly improved by the developments mentioned above. The mentioned and known can openers however are distinguished all by a hand grip formed of one or more parts, in which the can is held and the cutting mechanism is actuated.

Can openers designed as a transportable hand grip have the disadvantage that they may be misplaced due to their portability, which may lead to hectic and stress in the restaurant business if several workers wish to use a common can opener.

One disadvantage of the can opener connected to a transportable hand grip is the fact that the user must always take care that the hand grip and the can to be opened are held horizontally during the opening, so that no contents of the can unintendedly escapes from the partly opened can. Above all, cans with a large weight are very difficult to open for this reason, since the user during the complete opening procedure must hold the heavy can together with the can opener. If the user needs to open many heavy cans, as in restaurant businesses, a hand grip is not practical at all. For the above reason, the opening of large and heavy cans is partly not possible for some workers in large kitchens.

In order to avoid the disadvantage of the continuous holding of the can and the can opener, devices were also created, with which the can is to be opened guided on a support surface.

One possibility is described in GB 2059908. There, a support surface which is provided with a screw clamp which is placed on a working surface is disclosed. The can to be opened must be clamped into the screw clamp with much effort. A rod with a hook formation at one side, and with a hand grip at the opposite side, are used for opening can. A cutter plate in the vicinity of the hand grip is pushed through the can lid, after the hook formation has been hooked into the can edge. The can is cut open with a blade by way of the movement of the rod. This type of can opener demands a multitude of settings of the can fastening, before the actual opening of the can may be carried out.

Since this can opener consists of several parts, here too there exists the danger that the rod with the hand grip for opening is misplaced. Furthermore, much space is required for this multi-part can opener due to the support surface with the integrated screw clamp.

The British patent application GB 2309018 discloses a conventional handgrip-like can opener, which is mounted in a height-adjustable manner on a stand. Thereby, a can opener may be applied for right-handed people and for left-handed people. The can is placed on the support surface between two blocks arranged in a V-shaped manner, and the can opener on the stand is adapted to the can height, and is brought into connection with the edge of the can.

This device requires a stable and large support surface on which the can, the blocks and the stand for the can opener have space. If such a device is fastened in a kitchen in a stationary manner, then much space is lost to the can opener, since the support surface must be arranged horizontally. It is indeed in tightly spaced restaurant kitchens that such a can opener is not practical

### DESCRIPTION OF THE INVENTION

The present invention provides a manually operable can opener for semi-professional application with the comfort common today, which may be fastened for example in restaurant kitchens and snack bars in a space-saving manner, and which simplifies the opening of heavy cans.

The present invention also creates the possibility of permitting a handicapped person of independently opening cans with only one hand.

According to one aspect of the invention, a can opener to be actuated manually comprising a functional part for opening cans fastenable to a stand, wherein the functional part is cylindrical and comprises a crank, a cylinder axis, an abutment ring, and a fastening ring, the functional part insertable through two opposite sides of a hollow-cylindrical housing which is fastenable on the stand, and is mountable with a positive fit in a rotationally secured manner in the housing in at least one alignment relative to the cylinder axis, and securable in an axially fixed manner in the housing by way of a bayonet closure with a fastening ring, wherein the stand is fastenable with a fastening means on a vertical wall or a horizontal surface.

Various other features and advantages of the present invention will be made apparent from the following detailed description and the drawings.

### BRIEF DESCRIPTION OF THE DRAWINGS

The invention is hereinafter described in combination with the drawings.

FIG. 1 shows a frontal view of the can opener according to the invention, with a view of the cutter wheel of the functional part applied in the housing.

FIG. 2 shows an axial section of the housing, of the stand and of the support surface of the can opener, wherein the installed functional part together with the fastening ring and crank is represented in the lateral view.

FIG. 3 shows a section of the empty housing and of the stand.

FIG. 4 shows an axial section of the stand and of the empty housing.

FIG. 5a shows a view of the fastening ring, and FIG. 5b shows an axial view through the fastening ring along the line A-A of FIG. 5a.

FIG. 6 shows the functional part in a lateral view.

FIG. 7 shows the functional part in the plan view on the side surface from which the driver wheel exits.

### DESCRIPTION

The functional part 1 of a safety can opener is set forth in the embodiment described hereinafter. The cutting mechanism for opening cans is integrated into the functional part 1, which is cylindrical in shape. Classical cutting mechanisms may be applied in further design forms of the present invention.

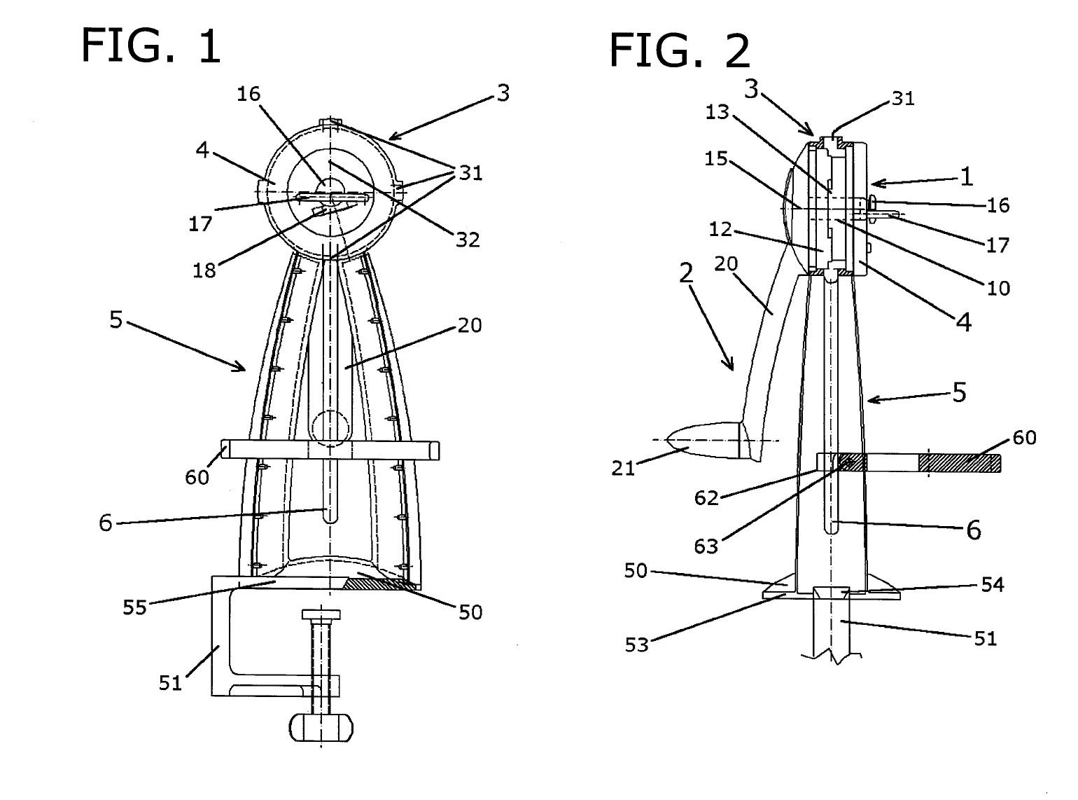

Functional part 1 is shown in FIGS. 1 and 2 and includes a driver shaft 10 (indicated in by dashed lines) that runs centrically and parallel to the cylinder axis 15 between two side surfaces of the functional part 1, the two side surfaces arranged perpendicular to the cylinder axis 15. A crank 2 comprised of a crank arm 20 and a crank grip 21 is connected to the driver shaft 10 in the vicinity of a side surface of the functional part 1. The crank 2 may be integrally formed on the driver shaft 10, or may be releasably connected to the driver shaft 10. One may also imagine a rotary grip being fastened instead of a crank 2. A driver wheel 16 is thus driven via the driver shaft 10 by way of the crank 2.

The driver shaft 10 exits on that side surface of the functional part 1 lying opposite the crank 2. The driver wheel 16 is assembled on the exiting driver shaft 10 in a rotationally fixed manner, so that the driver wheel 16 also turns in response to each rotational movement of the driver shaft 10. A can to be opened is clamped with an upper can bead between the driver wheel 16 and a cutter wheel 18 of the functional part 1. A two-point contact clip 17 lies on the upper edge of the can bead for stabilisation. The driver wheel 16 is driven and the clamped-in can rotates by way of rotating the crank 2.

The cutter wheel 18, whose axis is aligned perpendicular to the driver shaft 10 and which encloses an acute angle with the two-point contact clip 17, is located below the driver wheel 16, roughly below the can bead. As is known in the art, during opening of the can the cutter wheel 18 moves along the outer side of the can on the can bead and severs the bead by applying a separating force which is directed upwards. For opening cans, the crank 2 and the driver wheel 16 are rotated in one direction, so that the can is cut open. The can opener may be matched to left-handed people or right-handed people based on the installation of the functional part 1. The driver wheel 16 is also pulled in the direction of the cutter wheel 18 with the cutting actuation, thus holding the can in a secure manner. A slight rotation of the crank 2 in the counter direction pushes the driver wheel outwards, so that the clamping of the can is lifted.

An abutment ring 12 is integrally formed on the crank-side side surface of the functional part 1, enlarging the diameter of the functional part 1 and serving as an abutment for installation of the functional part 1 into a housing 3. Again, since the functional part 1 may be stuck and fixed on the housing 3 from both sides, the presented can opener may be assembled for left-handed people and right-handed people, by which means a greater comfort is achieved.

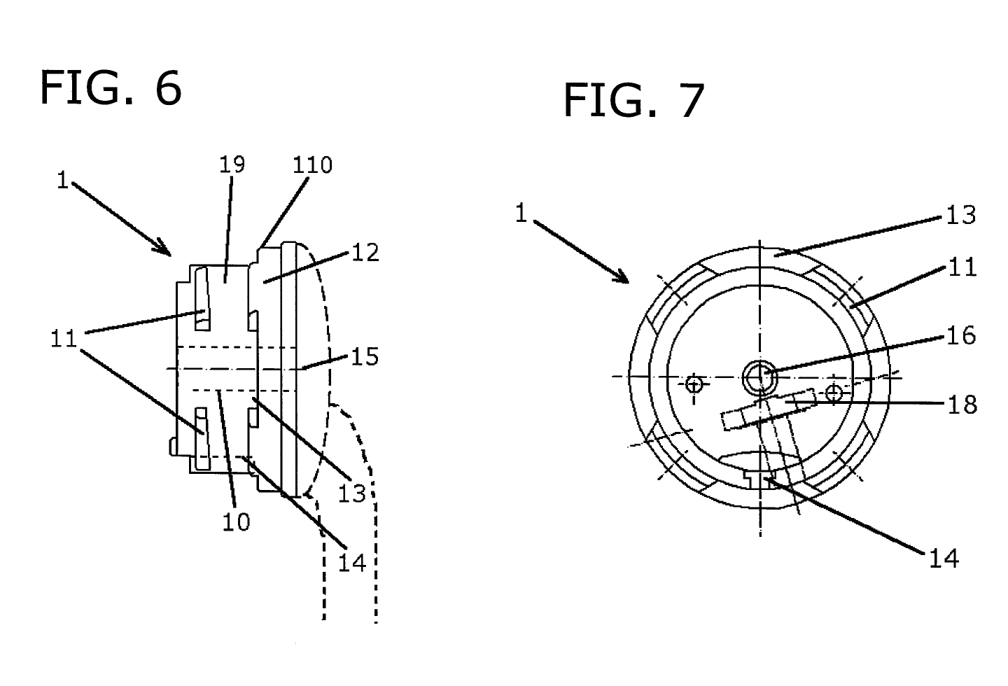

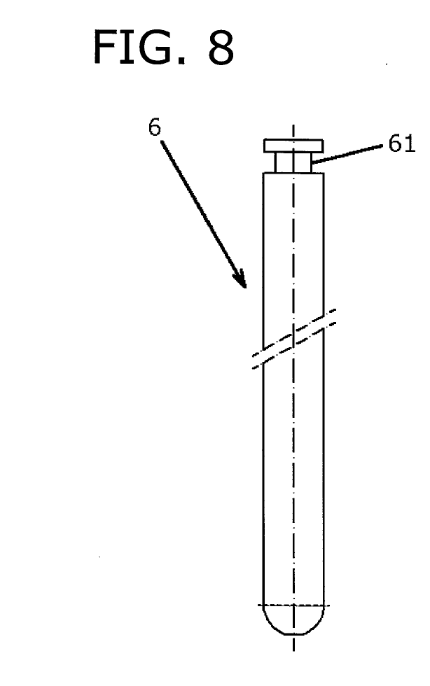

Referring to FIGS. 6 and 7, four threaded sections 11 are integrally formed in the functional part 1 and are directed radially outwards from a superficies 19 of the functional part 1. The threaded sections 11 on the superficies 19 of the functional part 1 are in the vicinity of the side surface from which the driver shaft 10 exits, and these sections are uniformly distributed on the periphery of the functional part 1. While four threaded sections have been described for securing functional part 1 to housing 3 (shown in FIGS. 1 and 2), other thread configurations are also possible; however, at least one threaded section 11 is included so that the functional part 1 may be fixed in the housing. Other embodiment forms are also conceivable, and these may be differently designed connection means which may be screwed in or snapped in.

At least one abutment ring recess 13 is recessed on the superficies 19 and into the abutment ring 12 of the functional part 1, so that the functional part 1 is fixable in the housing 3 (shown in FIGS. 1 and 2) in a rotationally fixed manner. The preferred embodiment comprises four abutment ring recesses 13 which are positioned offset to the threaded sections 11, and are arranged on a peripheral line on the superficies 19 parallel to the peripheral line on which the threaded sections 11 lie. Other embodiments of the can opener according to the invention are also envisioned, but would also include at least one abutment ring recess 13.

Functional part 1 also includes a thread-in milled recess 14 that reaches from the side surface of functional part 1 on the driver wheel side up to the abutment ring 12 and crosses at least one abutment ring recess 13. The thread-in milled recess 14 has the shape of a T-groove and is located parallel to the cylinder axis 15 in the superficies 19 of the functional part 1. This thread-in milled recess 14, on the superficies of the functional part 1, is aligned in a manner such that it is located below the driver wheel 16 and the cutter wheel 18, and lies at an approximately right angle to the two-point contact clip 17 (shown in FIGS. 1 and 2).

As is evident from the FIGS. 1-4, the functional part 1 is assembled in the already mentioned housing 3, which is formed annularly in a hollow-cylindrical manner, and is fastened on a stand 5. The annular housing 3 has a middle axis 32 and comprises at least one thorough-bore 31 directed radially inwards. Two through-bores 31 are arranged at the through-points of the middle axis 32 through the cylindrical housing 3 and are located at the 12 o'clock position and the 6 o'clock position. In addition to these two through-bores 31, yet a further through-bore 31 is arranged at the height of the housing middle point on the axis which is perpendicular to the middle axis. This position is hereinafter indicated as the 3 o'clock position, analogously to the view of FIG. 1.

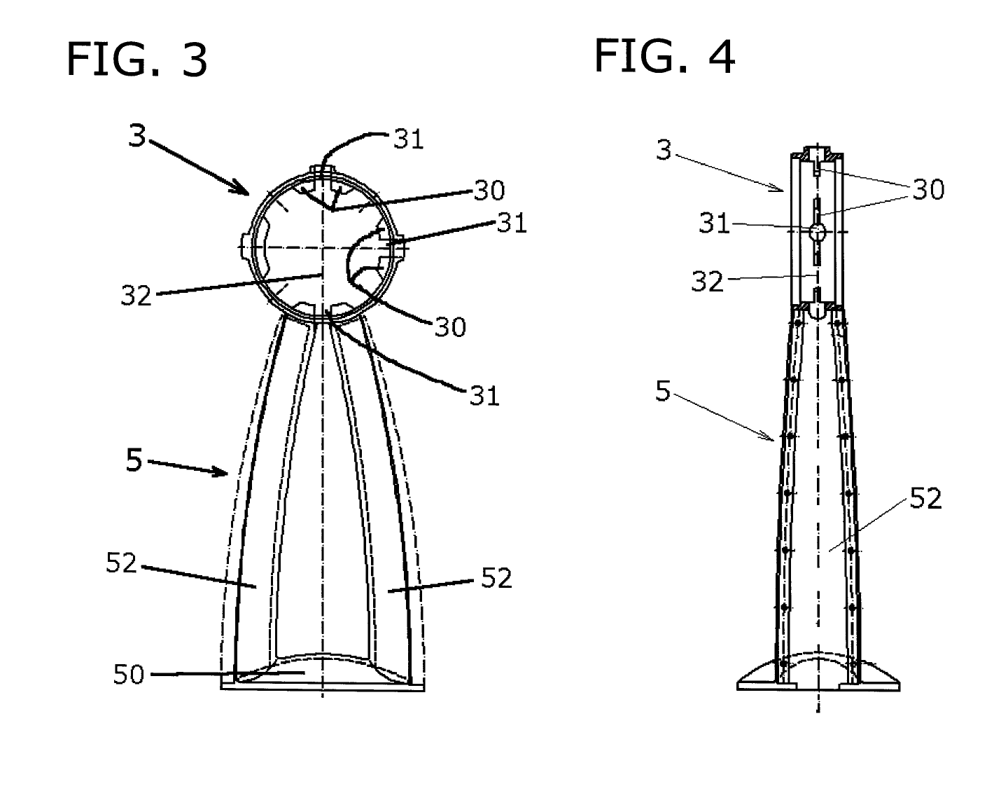

As shown in FIGS. 3 and 4, the inner surface of the cylindrical housing 3 comprises four locking ribs 30 that, with regard to their depth, are integrally formed centrally on the housing inner surface and are directed radially inwards to the housing middle point, the ribs 30 having roughly the same wall thickness as the housing 3. The locking ribs 30 are divided in two in the 3 o'clock, 6 o'clock and 12 o'clock positions since they are passed by the respective through-bore 31. The fourth locking rib 30, located in the 9 o'clock position, is of one part in the embodiment presented here. The surfaces of the four locking ribs 30 form an interrupted ring in the inside of the housing, which reduces the inner diameter of the housing 3.

Referring still to FIGS. 1-4, the functional part 1, along with the side surface which has the driver wheel 16, is inserted through one of the oppositely lying openings of the housing 3 crossing therewith. Thereby, the cylindrical functional part 1 is rotated such that the threaded sections 11 (see FIGS. 6 and 7) may pass the tapered inner diameter of the housing 3 at the height of the locking ribs 30. The at least one locking rib 30 engages into the at least one abutment ring recess 13 with a positive fit, by which means the functional part is fixed in the housing 3 in a rotationally fixed manner. In the embodiment shown here, in each case four locking ribs 30 and four abutment ring recesses 13 are selected, in order to ensure a high stability. As with the number of threaded sections 11 (see FIGS. 6 and 7) and the number of the abutment ring recesses 12, the number of the locking ribs 30 is also variable, but at least one locking rib 30 must be integrally formed. It is to be noted that the number of abutment ring recesses 13 should be equal to the number of locking ribs 30 to fit therewith.

Referring back to FIGS. 1 and 2, in order to also axially fix the functional part 1 in the housing, so that it does not slide out of the housing 3 in the direction of the cylinder axis 15, a fastening ring 4 is applied, which by way of a bayonet closure, creates a positive-fit connection of the fastening ring 4 to the functional part 1, and thus anchors the functional part 1 in the housing 3. The advantage of a bayonet closure is the small rotational angle which must be past for fastening. This angle varies, depending on the length of the threaded section 11 or the counter-thread section 40. Since the connection of the functional part 1 to the fastening ring 4 functions in the manner of a bayonet closure, only one flank of the threaded section 11 comes to bear. This flank affects a resulting displacement of the functional part 1 as compared to the fastening ring 4. Other closure types are also conceivable instead of a bayonet closure, such as a screw closure for example.

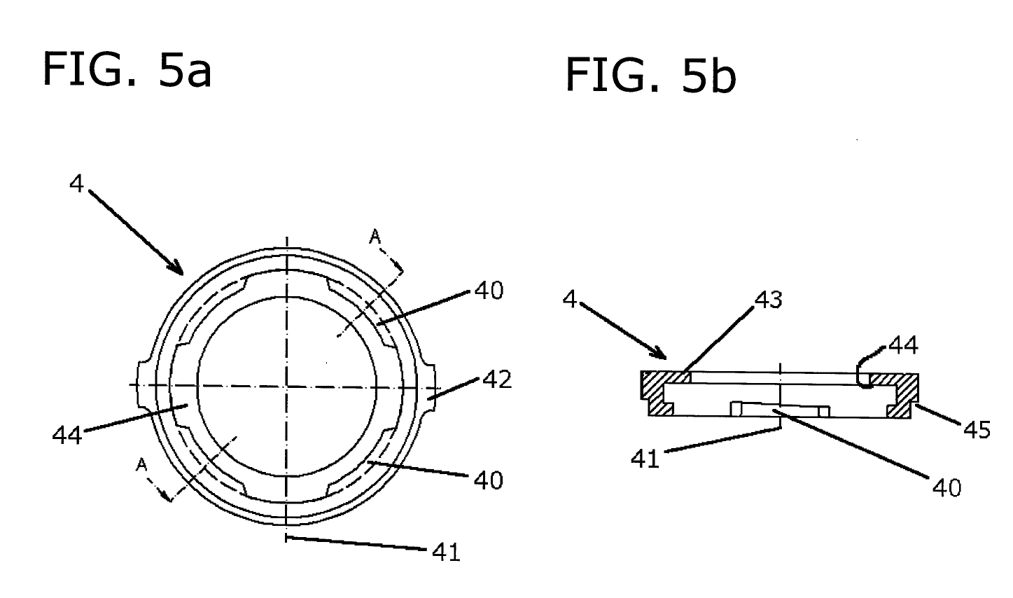

As shown in FIGS. 5a and 5b, the fastening ring 4 comprises a ring middle axis 41, at least one outer-lying grip cam 42, an outer closure surface 43, an inner closure surface 44, and at least one counter-thread section 40 directed radially inwards to the ring middle axis 41. In the embodiment shown here, four counter-thread sections 40 are integrally formed perpendicular to the superficies 19 (shown in FIG. 6) and in the direction of the ring middle axis 41.

The inner diameter is selected such that the fastening ring 4 may be placed over the region of the functional part 1 projecting out of the housing 3 to engage into the housing 3 up to an annular shoulder. Counter-thread sections 40 are integrally formed on the fastening ring 4 perpendicular to the superficies 19 (see FIG. 6) and in the direction of the middle axis. Similar to the increase of the thickness of the threaded sections 11, the thickness of the counter-thread sections 40 increases in the rotational direction of the fastening ring 4, so that upon screwing the fastening ring 4 and the functional part 1 together in the manner of a bayonet, the two parts are held in the housing with a positive and non-positive fit, pulling against one another.

If the fastening ring 4 is pushed over the cylindrical functional part 1, the fastening ring 4 is aligned in a manner such that the threaded sections may slide between the counter-thread sections 40. The fastening ring 4 is pushed onto the functional part 1 up until the annular shoulder 45 abuts on the side surface of the functional part 1, on which the driver wheel 16 is assembled.

If the fastening ring 4 is then rotated, the counter-thread sections 40 engage behind the thread sections 11, and the distance between the fastening ring 4 and the functional part 1 is reduced by way of the rotation, by which means the functional part 1 is fixed in the housing 3. The functional part 1 is pressed onto the housing 3 in the direction of the fastening ring 4, so that the peripheral shoulder 110 bears onto the housing edge, while the fastening ring 4 with its annular shoulder 45 is pressed onto the oppositely lying side of the housing 3.

Referring to FIGS. 1 and 2, the stand 5 is shown with two legs 52 and at the end of both stand legs 52 comprises a stand foot 50, by way of which the stand 5 may be assembled on a vertical wall or on a horizontal surface. For the assembly, a fastening means 51 is provided, which in one example may be a screw clamp. A rapid assembly and disassembly of the stand 5 is possible with such a screw clamp. If one wishes more space, the stand may also be permanently screwed on a surface. For this, a fastening plate 53 is thus releasably held in the stand foot. This fastening plate 53 comprises a groove 54, in which an arm 55 of the screw clamp may be inserted according to a tongue and groove principle. The fastening plate 53 also comprises some through-holes, so that the fastening plate 53 may be screwed on a surface by way of screws and thereafter the stand 5 may be pressed on, in order to get into a snap-in retaining position.

For assembly on a surface in a vertically standing manner, the functional part 1 is directed such that the two-point contact clip 17 lies approximately horizontally, and the cutter wheel 18 faces roughly in the direction of the 6 o'clock through-bore 31. In order to prevent the opened can from falling down, a support rod 6 on which a support surface 60 is held in a height-adjustable manner is applied. With the fastening of the functional part 1 in the housing 3, the start of the support rod 6, which is provided with an annular groove 61 (see FIG. 8), is inserted through the through-bore 31 directed vertically downwards, and is threaded into the T-shaped thread-in milled recess 14 (see FIG. 6) of the functional part 1, so that the support rod projects out of the housing 3 and is firmly anchored in the functional part 1. The distance of the support surface 60 to the through-bore 31 may be varied with known means, and the support surface 60 may be fastened at variable distances, adapted to the respective can height. If the can detaches from the seat in the driver wheel 16, then it lowers onto the support surface 60.

For opening cans, the functional part 1 must in each case be aligned and fastened in the housing 3, such that the thread-in milled recess 14 is directed vertically downwards and lies below the cutter wheel 18 and the driver wheel 16, since otherwise the support rod 6 and the support surface 60 fastened thereon may not be positioned below the can.

Referring still to FIGS. 1 and 2, for the assembly of the support rod 6 the two stand legs 52 of stand 5 are distanced apart from one another, so that the support rod 6 may run therebetween. The support surface 60 is comprised preferably of a plastic grating, which is held pivotally about a pivot 63 on a slider 62. In the pivoted-out position, the support surface 60 presses onto the support rod 6. By way of pivoting the support surface 60 to the top, the clamping with the support rod 6 is lifted, and the support surface 60 may be adjusted in height. If, however, the weight of an opened can presses onto the support surface 60, then the clamping effect is automatically increased.

In light of the comprehensive assembly possibilities, the can opener according to the invention may in particular also be used in professional or semi-professional small kitchens, where usually enormous space problems exist. The assembly of the can opener is in no way limited to a working surface, but may be fastened below a hanging cupboard or on a wall by way of the fastening plate 53. The assembly may also be affected with the fastening means 51 in the form of a screw clamp below or on a working plate. In each assembly position, the support rod may be assembled in the correct position, so that the can to be opened may always be supported. Accordingly, a single-handed operation is also possible.

What is claimed is:

1. A can opener to be actuated manually comprising a functional part for opening cans fastenable to a stand, wherein the functional part is cylindrical and comprises a crank, a cylinder axis, an abutment ring, and a fastening ring, the functional part insertable through two opposite sides of a hollow-cylindrical housing which is fastenable on the stand, and is mountable with a positive fit in a rotationally secured manner in the housing in at least one alignment relative to the cylinder axis, and securable in an axially fixed manner in the housing by way of a bayonet closure with a fastening ring, wherein the stand is fastenable with a fastening means on a vertical wall or a horizontal surface.

2. The can opener of claim 1, wherein the housing comprises at least one radially inwardly directed locking rib.

3. The can opener of claim 1, wherein the cylindrical functional part has at least one thread section which is directed radially outwards from the superficies of the functional part and which with at least one counter-thread section on the fastening ring forms a connection in the manner of bayonet closure.

4. The can opener of claim 1, wherein the abutment ring comprises at least one abutment ring recess.

5. The can opener of claim 2, wherein the at least one locking rib engages with a positive fit into the at least one abutment ring recess, by which means the functional part may be mounted in the housing in a rotationally secured manner.

6. The can opener of claim 1, wherein the housing comprises at least one radially arranged through-bore.

7. The can opener of claim 6, wherein the through-bore crosses a locking rib.

8. The can opener of claim 1, wherein the functional part comprises a thread-in milled recess shaped as a T-groove, in the outer superficies parallel to the cylinder axis.

9. The can opener of claim 8, wherein the thread-in milled recess crosses the at least one abutment ring recess.

10. The can opener of claim 6 further comprising a thread-in milled recess shaped as a T-groove, in the outer superficies parallel to the cylinder axis and wherein a support rod is positioned through the at least one through-bore and is threaded into the thread-in milled recess by way of an annular groove.

11. The can opener of claim 10, further comprising a support surface for holding opened cans at variable distances to the through-bore fastened along the support rod.

12. The can opener of claim 11, wherein the support surface via a pivot is mounted on a slider which is displaceable on the support rod such that a clamping on the support rod is effected with a pressure on the support surface.

13. The can opener of claim 10, wherein the stand comprises two stand legs and a stand foot, wherein the stand legs are distanced to one another, and at least one through-bore passes through the housing therebetween, whilst the support rod runs between the stand legs.

14. The can opener of claim 1, wherein the fastening means is a screw clamp.

15. The can opener of claim 13, further comprising a stand plate fixably held in the stand foot, and by way of this plate, the stand is rigidly mountable on a surface.
